(19) United States
(12) Patent Application Publication
(10) Pub. No.: US 2014/0373523 A1
(43) Pub. Date: Dec. 25, 2014

(54) Hydrostatic Travel Drive

(71) Applicant: Robert Bosch GmbH, Stuttgart (DE)

(72) Inventors: James Brown, Lochgelly (GB); Iain Edward, Kelty (GB)

(21) Appl. No.: 14/303,702

(22) Filed: Jun. 13, 2014

(30) Foreign Application Priority Data
Jun. 20, 2013 (DE) 10 2013 211 621.7

(51) Int. Cl. F15B 15/02

(52) U.S. Cl. CPC F15B 15/02
USPC 60/420

(57) ABSTRACT

A hydrostatic travel drive has a variable displacement pump, two hydraulic motors arranged in series and supplied with pressure medium in a closed hydraulic circuit by the variable displacement pump, and a flow control valve, via which a pressure medium volume flow flows from a line segment between the two hydraulic motors to a pressure sink. The flow control valve is integrated into a housing of a first of the two hydraulic motors.

This application claims priority under 35 U.S.C. §119 to patent application no. DE 10 2013 211 621.7, filed on Jun. 20, 2013 in Germany, the disclosure of which is incorporated herein by reference in its entirety.

The disclosure relates to a hydrostatic travel drive having a variable displacement pump, having two hydraulic motors, which are arranged in series and are supplied with pressure medium in a closed hydraulic circuit by the variable displacement pump, and having a flow control valve, via which a pressure medium volume flow flows from the line segment between the two hydraulic motors to a pressure sink.

Hydrostatic travel drives of this kind can be used in general on vehicles but especially on agricultural utility vehicles, such as tractors.

### BACKGROUND

DE 10 2010 015 498 A1 has disclosed a hydrostatic travel drive in which a plurality of hydraulic motors is supplied with pressure medium in a closed hydraulic circuit by a common variable displacement pump. In this arrangement, each wheel of the front and rear axle of a vehicle is assigned a hydraulic motor (wheel motor), of which in turn two are connected in series, with the result that, in an all-wheel drive, the left-hand wheels and the right-hand wheels respectively are driven by means of two hydraulic motors connected in series.

Multi-stroke radial piston motors of the kind known, for example, from DE 38 28 131 A1 are often used as hydraulic motors fitted directly on the wheels.

In the known hydrostatic travel drive, there is an external valve block for the flow control valve. This gives rise to considerable costs through its production and its mounting on a vehicle component or on a hydraulic motor.

### SUMMARY

It is an object of the disclosure to develop the known hydrostatic travel drive further in such a way that the costs for its production are reduced.

This object is achieved by a hydrostatic travel drive which is provided with the features from the claims and in which the flow control valve is furthermore integrated into the housing of a first of the two hydraulic motors.

Advantageous embodiments of a hydrostatic travel drive according to the disclosure can be found in the claims.

The flow control valve preferably withdraws the controlled pressure medium volume flow directly from the first port of the first hydraulic motor, said port being connected to the line segment between the two hydraulic motors. By means of this withdrawal, a certain slip with respect to the second hydraulic motor can be set for the first hydraulic motor where the first hydraulic motor is the downstream hydraulic motor.

It can be advantageous if the pressure medium volume flow limited by means of the flow control valve flows to the branch of the hydraulic circuit between a second port of the first hydraulic motor and the variable displacement pump. In particular, the pressure medium volume flow limited by means of the flow control valve can flow directly to the second port of the first hydraulic motor. Simple boring is then possible between the two ports of the first hydraulic motor.

A check valve, which blocks the flow to the line segment between the two hydraulic motors, is advantageously arranged in series with the flow control valve. As a result, it is not possible for pressure medium to flow via the flow control valve if the first hydraulic motor is the upstream hydraulic motor of the two hydraulic motors.

It is regarded as particularly advantageous if the pressure medium volume flow limited by means of the flow control valve flows through the housing of the first hydraulic motor to a tank. In that case, the pressure medium volume flow flowing through the flow control valve contributes to the cooling of the first hydraulic motor.

In the drawings, two illustrative embodiments of a hydrostatic travel drive according to the disclosure are illustrated as circuit diagrams, and a usable flow control valve is illustrated in a longitudinal section.

### BRIEF DESCRIPTION OF THE DRAWINGS

The disclosure is now explained in greater detail by means of the drawings, in which:

FIG. 1 shows the circuit diagram of the first illustrative embodiment of a hydrostatic travel drive according to the disclosure, in which the pressure medium volume flowing via the flow control valve drains to a tank;

FIG. 2 shows the circuit diagram of the second illustrative embodiment of a hydrostatic travel drive according to the disclosure, in which the pressure medium volume flowing via the flow control valve drains to one port of a hydraulic motor; and

FIG. 3 shows a flow control valve that can be used in the travel drives shown in FIGS. 1 and 2.

### DETAILED DESCRIPTION

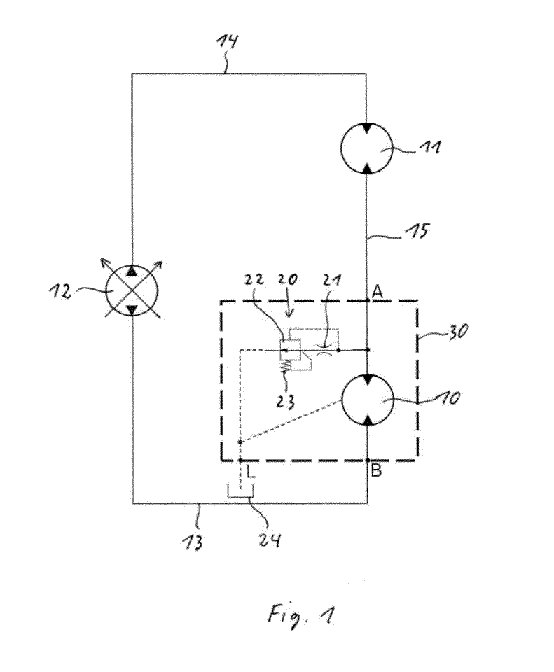

According to FIGS. 1 and 2, a first hydraulic motor 10 and a second hydraulic motor 11 are arranged in series in a closed hydraulic circuit, which is illustrated in greatly simplified form in comparison with the closed hydraulic circuits used in practice. For example, the addition of pressure medium to replace the amount of pressure medium withdrawn from the circuit by purging of the circuit and leakage is not shown specifically. The closed hydraulic circuit also contains a variable displacement pump 12. A first working line 13 runs between the first hydraulic motor 10 and the variable displacement pump 12, and a second working line 14 runs between the second hydraulic motor 11 and the variable displacement pump. The variable displacement pump 12 can be adjusted between a maximum positive displacement and a maximum negative displacement, and it is therefore possible, while retaining the direction of rotation of the variable displacement pump, for working line 13 to be the high-pressure line and working line 14 the low-pressure line or for working line 14 to be the high-pressure line and working line 13 to be the low-pressure line, and for the hydraulic motors to be driven in opposite directions of rotation. In this way, a vehicle can be driven backwards and forwards.

The two hydraulic motors 10 and 11 are each assigned to one wheel of a vehicle axle and drive the wheel directly. Between them there is a line segment 15 of the hydraulic circuit.

The first hydraulic motor 10 is assigned a flow control valve 20 which, as is customary, has an orifice 21 and a pressure compensator 22, which is in series with the orifice and the control piston of which is acted upon in the closing direction by the pressure upstream of the orifice and in the opening direction by the pressure downstream of the orifice and by a spring 23. By means of the pressure equivalent of the spring 23, a particular pressure drop across the orifice 21 is thus set. Together with the size of the flow cross section of the orifice, this results in the constant pressure medium volume flow flowing via the flow control valve.

Both the inlet of the flow control valve 20 shown in FIG. 1 and also that of the flow control valve shown in FIG. 2 are connected to port A of the first hydraulic motor connected to line segment 15.

In the two illustrative embodiments shown in FIGS. 1 and 2, the flow control valve 20 is furthermore integrated into the housing 30 of the first hydraulic motor 10, which is indicated by a dashed rectangle in the figures.

In the illustrative embodiment shown in FIG. 1, the pressure medium flow flowing from port A of the first hydraulic motor 10 via the flow control valve 20 flows into the housing 30 and, via the leakage port L thereof, flows back to a tank 24. As it passes through the housing, the pressure medium flowing via the flow control valve can absorb heat and carry it away into the tank. It therefore contributes to the cooling of the first hydraulic motor 10.

In the illustrative embodiment shown in FIG. 2, the outlet of the flow control valve 20 is connected to the second port B of the hydraulic motor 10. The pressure medium flow flowing from port A of the first hydraulic motor 10 via the flow control valve 20 thus does not flow through the housing 30 but via port B into working line 13. However, it is a precondition for this that working line 13 should be the low-pressure line.

If working line 13 is the high-pressure line, no pressure medium should flow from port B to port A of the hydraulic motor via the flow control valve 20. For this purpose, a check valve 25, which blocks flow from port B towards the flow control valve 20, is arranged in the duct between port B and the flow control valve. The check valve could also be arranged between port A and the flow control valve.

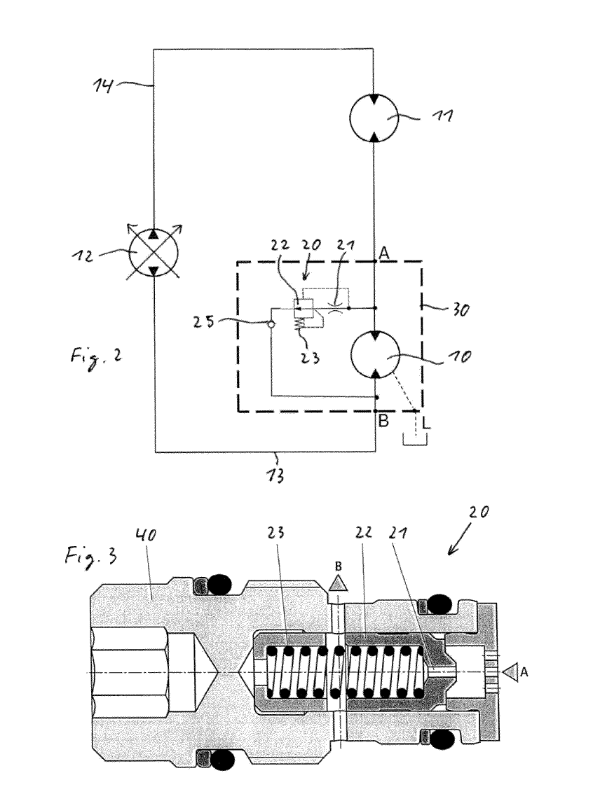

The flow control valve according to FIG. 3 is designed as a built-in valve, which can be inserted into a corresponding bore in the housing 30 of the hydraulic motor 10. The valve has a cartridge-type housing 40 having a blind hole in which the bush-type control piston or bush-type pressure compensator 22 can move axially and, in doing so, controls a flow cross section between the open end thereof and a plurality of radial housing bores 41. Located centrally in the face of the pressure compensator 22 is an axial bore, which forms the orifice 21. A spring 23 imposes a load on the pressure compensator 22 tending to enlarge the flow cross section at the radial bores 41.

The inlet of the flow control valve is denoted by A, while the outlet is denoted by B.

If there is a flow through the valve 20 in the flow direction from A to B, the pressure prevailing in duct A exerts a force on the pressure compensator tending to reduce the flow cross section at the radial bores 41. The pressure compensator goes into a control position and, in the process, restricts the flow cross section at the radial bores 14 until the forces exerted by the pressure in the spring chamber and by the spring 23 are in equilibrium with the force exerted by the pressure in duct A. The pressure in the spring chamber is then less than the pressure in duct A by precisely the pressure equivalent of the spring 23. The pressure compensator 20 thus sets a constant pressure drop across the orifice 21 and hence a constant pressure medium volume flow.

In a volume flow direction from B to A, the return flow takes place freely via bore 21, which is then merely a restriction. To prevent this return flow, there is the check valve 25 in the illustrative embodiment shown in FIG. 2.

What is claimed is:

1. A hydrostatic travel drive, comprising:
a variable displacement pump configured to supply a pressure medium having a pressure medium volume flow, in a closed hydraulic circuit, to a first hydraulic motor and a second hydraulic motor,
wherein the first hydraulic motor and the second hydraulic motor are connected in series via a line segment; and
a flow control valve is integrated into a housing of the first hydraulic motor.

2. The hydrostatic travel drive according to claim 1, wherein:
the first hydraulic motor includes a first port that is connected to the line segment; and
the flow control valve is configured to withdraw the pressure medium volume flow directly from the first port.

3. The hydrostatic travel drive according to claim 2, wherein the flow control valve is configured to direct the pressure medium volume flow to a branch of the hydraulic circuit between a second port of the first hydraulic motor and the variable displacement pump.

4. The hydrostatic travel drive according to claim 3, wherein the flow control valve is configured to direct the pressure medium volume flow directly to the second port of the first hydraulic motor.

5. The hydrostatic travel drive according to claim 3, further comprising:
a check valve positioned in series with the flow control valve,
wherein the check valve is configured to block the pressure medium volume flow from flowing to the line segment between the first hydraulic motor and the second hydraulic motor.

6. The hydrostatic travel drive according to claim 1, wherein the flow control valve is configured to direct the pressure medium volume flow to flow through the housing of the first hydraulic motor to a tank.
